(19) United States
(12) Patent Application Publication
(10) Pub. No.: US 2006/0249198 A1
(43) Pub. Date: Nov. 9, 2006

(54) Photovoltaic power generating unit having radiating fins

(76) Inventor: Jin-Geun Rhee, Daejeon (KR)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/429,660

(22) Filed: May 5, 2006

(30) Foreign Application Priority Data
May 9, 2005 (KR) 10-2005-0038345
May 26, 2005 (KR) 10-2005-0044389

(51) Int. Cl. H02N 6/00

(52) U.S. Cl. 136/246

(57) ABSTRACT

A photovoltaic power generating unit is disclosed. The photovoltaic power generating unit includes a plurality of solar cells, a concentrating lens for concentrating sun light on the solar cell, which is installed on the vertical upper part of the solar cell, and a concentrating type solar cell module provided with a protective member which is attached to the lower part thereof for protecting the solar cell from external impact. In addition, the photovoltaic power generating unit of the present invention includes a radiating part for dissipating heat created in the solar cell module to the atmosphere. The radiating part consists of a radiating plate bonded to the lower part of the protective member through a thermal resin bonding agent and a plurality of radiating fins protruding downwardly from the radiating plate. Meanwhile, a frame is installed on both edges of the solar cell module to entirely support the solar cell module, and a frame extension part protruding downwardly from the frame is arranged. At least one elastic force fixation device is installed between the frame extension part and the radiating plate to stably fix the radiating part to the solar cell module.

### FIELD OF THE INVENTION

The present invention relates to a photovoltaic power generating unit, and more particularly, to a photovoltaic power generating unit mounted with a plurality of radiating fins on a lower part of a solar cell module.

### DESCRIPTION OF THE RELATED ART

FIGS. 1a and 1b are top and sectional views showing a solar cell module of a photovoltaic power generating unit according to the prior art.

Referring to FIGS. 1a and 1b, a solar cell module 10 includes a solar cell 14 consisting of a plurality of cells, a reinforced transparent fiber glass 12 placed over the solar cell 14 for protecting it, and a protective member 18 bonded to a lower part of the solar cell 14 with a bonding agent 16. EVA base bonding agent is generally used as a bonding agent. The protective member consists of Tedler, aluminum, etc.

In addition, the light efficiency of a solar cell which has been improved until now is 20% or so due to limitation of the materials used in the solar cell. To increase the efficiency of a photovoltaic power generating unit, many studies and much effort have been made. 2A method for increasing the efficiency has been proposed in which a Fresnel lens is installed on an upper part of the solar cell to concentrate light on the solar cell, thereby increasing the efficiency.

FIG. 2 is a view showing a light-concentrating-type photovoltaic power generating unit mounted with a Fresnel lens (F) disclosed in Korean patent No. 466, 257. When a concentrating-type solar cell module as described above is used, two to three or more times as much light as that which is normally received is concentrated on one a solar cell to rapidly increase a temperature inside the solar cell, and thus reduces the photoelectron conversion efficiency.

To solve above problem, radiation is to be made through air by a radiating plate mounted on a lower surface of the protective member. The radiating plate mounted with radiating fins formed of aluminum is bonded to the lower surface of a protective member through a thermal resin. However, there arises a problem in that the radiating plate bonded to the lower surface of the protective member is easily flaked off because the boding force of thermal resin is reduced due to increasing heat that is created from light concentrated by the Fresnel Lens.

### SUMMARY OF THE INVENTION

Accordingly, an object of the present invention is to provide a photovoltaic power generating unit in which a plurality of radiating fins, a radiating plate or both of them for dissipating heat created in a concentrating-type solar cell module is stably fixed to the solar cell module.

A photovoltaic power generating unit according to one preferred embodiment of the present invention includes a plurality of solar cells and a concentrating-type solar cell module mounted with a concentrating device for concentrating sun light on the solar cell. In addition, the photovoltaic power generating unit includes a radiating part for dissipating heat created in the solar cell module to the atmosphere.

The radiating part consists of a radiating plate attached to the lower part of the solar cell module and a plurality of radiating fins protruding downwardly from the lower part of the radiating plate and arranged parallel to each other. In addition, a pair of frames is provided on both edges of the solar cell module for entirely supporting the solar cell module, and a frame extension protruding downwardly from the frame is arranged. At least one elastic force fixation device is provided to the frame extension part and stably fixes the radiating part to the solar cell module.

Preferably, an elastic force fixation device consists of a supporting part connected to the frame extension part and protruding upwardly, and an elastic part fitted between the supporting part and the radiating plate. More preferably, the supporting part consists of a spring fixation element for securely fixing the spring of the elastic part, and an elastic force controller for controlling the elastic force of the spring.

Meanwhile, a plurality of radiating fins are installed parallel to the frame, and the photovoltaic power generating unit of the present invention further includes a radiating fin support which penetrates through a plurality of radiating fins and is connected to the elastic force fixation device to support the radiating fins. Additionally, the radiating fin support includes a radiating fin fixation element arranged tightly to at least one radiation fin for fixing the radiating fin support to the radiating fin.

A photovoltaic power generating unit according to another embodiment of the present invention includes a plurality of the solar cell and a concentrating-type solar cell module mounted with a concentrating device for concentrating sun light on the solar cell. In addition, a photovoltaic power generating unit of the present invention includes a radiating part for dissipating heat created in the solar cell module to the atmosphere. The radiating part is provided with a plurality of radiating fins protruding downwardly from the lower part of the radiating plate and arranged parallel to each other. A pair of frames is provided on both edges of the solar cell module parallel to the radiating fins for entirely supporting the solar cell module, and a frame extension part protruding to the lower part of the frame is installed. A plurality of radiating fin fixation element penetrates through a plurality of radiating fins and is connected to the frame extension part, thereby stably fixing the radiating fins.

Preferably, the photovoltaic power generating unit of the present invention includes a radiating fin fixation element arranged tightly to at least one radiation fin for fixing the radiating fin support to the radiating fin.

A photovoltaic power generating unit of the present invention further includes an elastic force fixation device consisting of a supporting part protruding upwardly and downwardly, and an elastic part fitted between the supporting part and the frame extension part, wherein the radiating support is connected to the frame extension part through the elastic force fixation device.

It is to be understood that the foregoing general description and following detailed description are exemplary and explanatory and are intended to provide further explanation of the invention.

### BRIEF DESCRIPTION OF THE DRAWINGS

The accompanying drawings, which are included to provide a further understanding of the invention and are incorporated in and constitute a part of this specification, illustrate embodiments of the invention together with the description. In the drawings:

FIG. 1 is a sectional view showing a solar cell module of a photovoltaic power generating unit according to the prior art;

FIG. 2 is a view showing the concept of a condensing type photovoltaic power generating unit using a Fresnel lens; and

FIGS. 3 to 6 are sectional views showing a photovoltaic power generating unit according to the present invention.

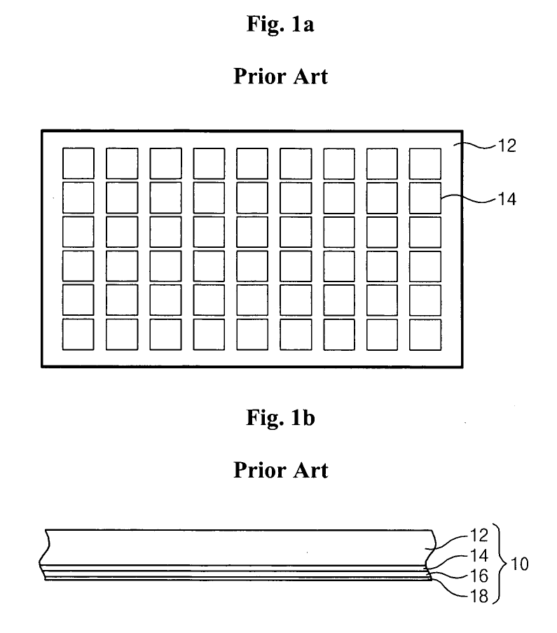

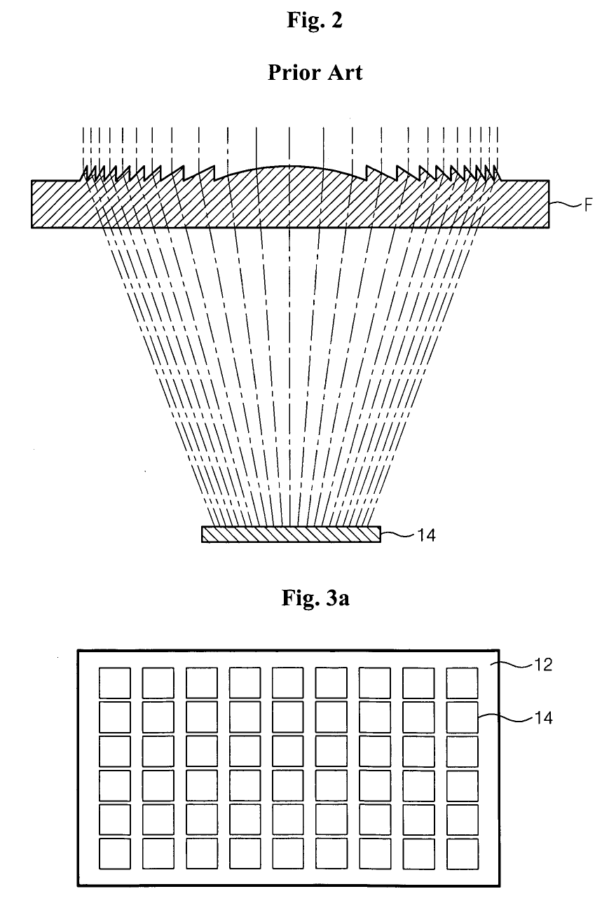

### DETAILED DESCRIPTION OF THE PREFERRED EMBODIMENTS

Hereinafter, the preferred embodiments of the present invention will be described in more detail referring to the accompanying drawings.

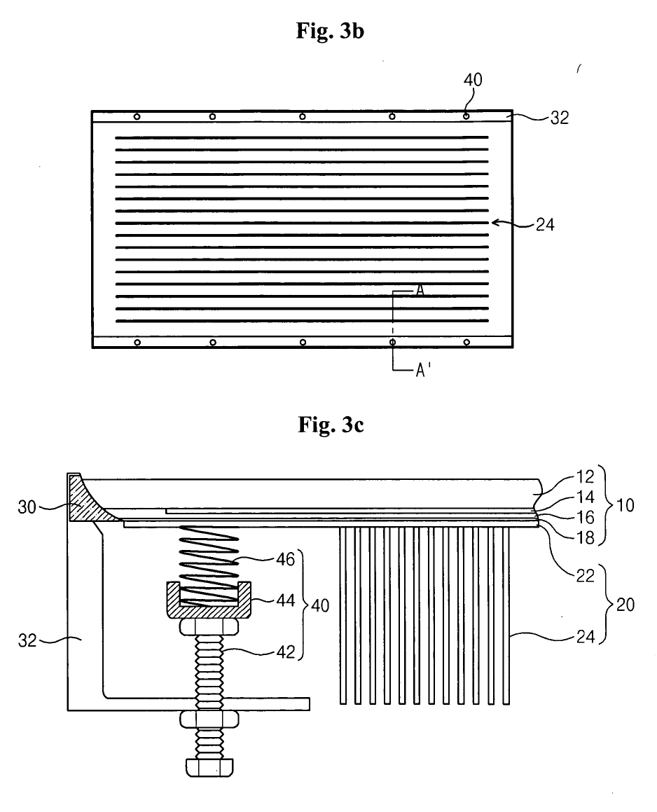

FIGS. 3a, 3b and 3c are views showing a top, a bottom and an exploded section, respectively, of a photovoltaic power generating unit according to a preferred embodiment of the present invention.

Referring to the above drawings, a solar cell module 10 as disclosed in the prior art is installed in the photovoltaic power generating unit according to the preferred embodiment of the present invention. The solar cell module 10 includes a solar cell 14 consisting of a plurality of cells, a transparent fiber glass 12 placed over the solar cell for protecting it, and a protective member 18 bonded to a lower part of a solar cell with a bonding member 16 and formed of aluminum. A Fresnel lens or a reflective plate (not shown) is installed over the solar cell module to concentrate incident light on the solar cell module 10.

In addition, a radiating plate 22 is bonded to the lower part of the solar cell module 10 using a thermal resin bonding agent (not shown), and a plurality of radiating fins is mounted to the lower part of the radiating plate 22 to form a radiating member 20. The radiating member 20 as a part radiated through air is formed of aluminum which has a high thermal conductivity.

A frame 30 is installed on both edges of the solar cell module 10 to entirely support the solar cell module 10. A frame extension part 32 extending downwardly from each frame 30, preferably extending parallel to the radiating plate 22 is installed. An elastic force controller 42 is fixed, which is controlled up and down, to the frame extension part 32 which extends practically parallel to the radiating plate 22 as described above. A spring fixation element 44 is installed over the elastic force controller 42 to prevent a spring 46 from being moved right and left and support it, consisting of a radiating plate support. The spring 46 is fitted between the spring fixation element 44 and the radiating plate 22, thereby fixing stably the radiating portion 20 together with the radiating support to the solar cell module 10. The elastic force controller 42 consists of a bolt and nut combination through which the position of the spring fixation member 44 with respect to the frame extending part 32 is optionally controlled. A configuration as described above makes the elastic force of the spring to be optionally controlled. In this preferred embodiment, a bolt and nut combination is used as the elastic force controller 42, but any member and part, if controlling the elastic controller up and down is possible, will be considered for this function.

A plurality of the elastic force fixation device 40 consisting of the elastic force controller 42, the spring fixation element 44 and the spring 46 are arranged to the frame extension part 32 of the frame 30 formed along both edges of the solar cell module 10. Through elastic force of the spring 46, the radiating part 20 is stably fixed to the solar cell module 10.

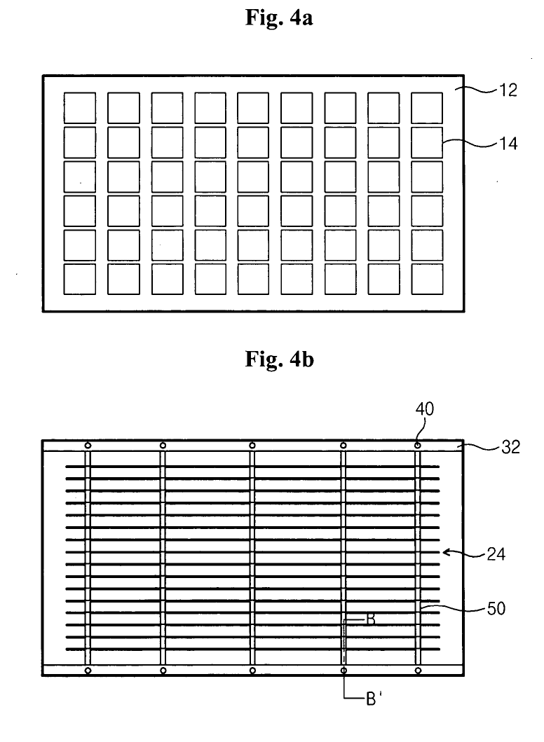

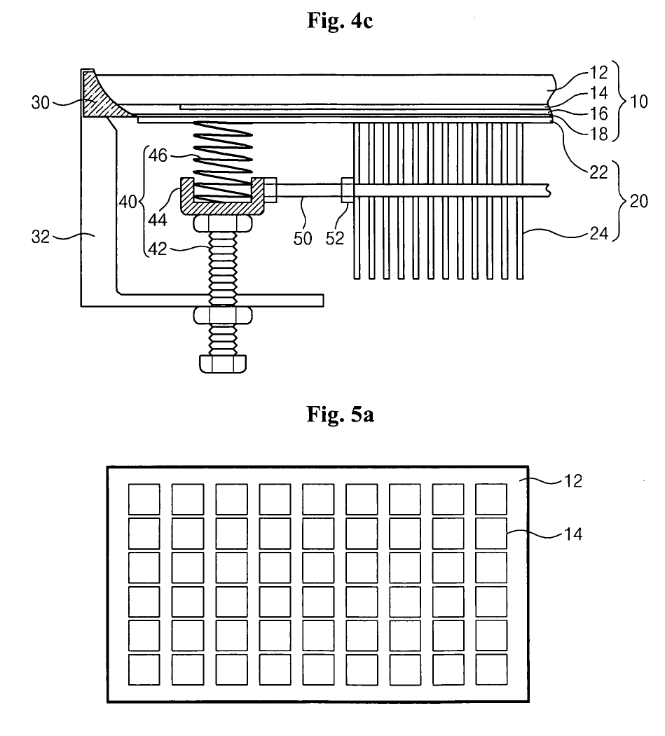

FIGS. 4a and 4b are views showing, respectively, a top and a bottom of a photovoltaic power generating unit according to the another preferred embodiment of the present invention.

FIG. 4c is an exploded sectional view taken along the line B-B in FIG. 4b.

In the photovoltaic power generating unit shown in FIGS. 4a-4c, a configuration of it is the same as that shown in FIGS. 3a-3c except for the addition of a radiating fin support 50. The radiating fin support 50 is installed practically parallel to the radiating plate 18, one end of which is fixed to the spring fixation element 44 and the opposing end of which penetrates through each radiating fin 24, thereby individually supporting them. At this point, each radiating fin 24 is preferably arranged substantially vertical to the radiating plate 18. Even though a deformation of the radiating fin 24 is made due to over heating, the radiating part 20 is stably fixed to the solar cell module 10 under the configuration as described above. For securely fixing the radiating fin 24 through the radiating fin support 50, the radiating fin support 50 is preferably provided with a radiating fin fixation part such as a nut 52 and a recess (not shown) mated with the nut 52 as shown in FIG. 4c. In the present embodiment, one end of the radiating fin is configured to be fixed to the spring fixation element, but it is well known to the person skilled in the art that a bolt and nut instead of the spring fixation element 44 may be employed if it is secured to be moved up and down.

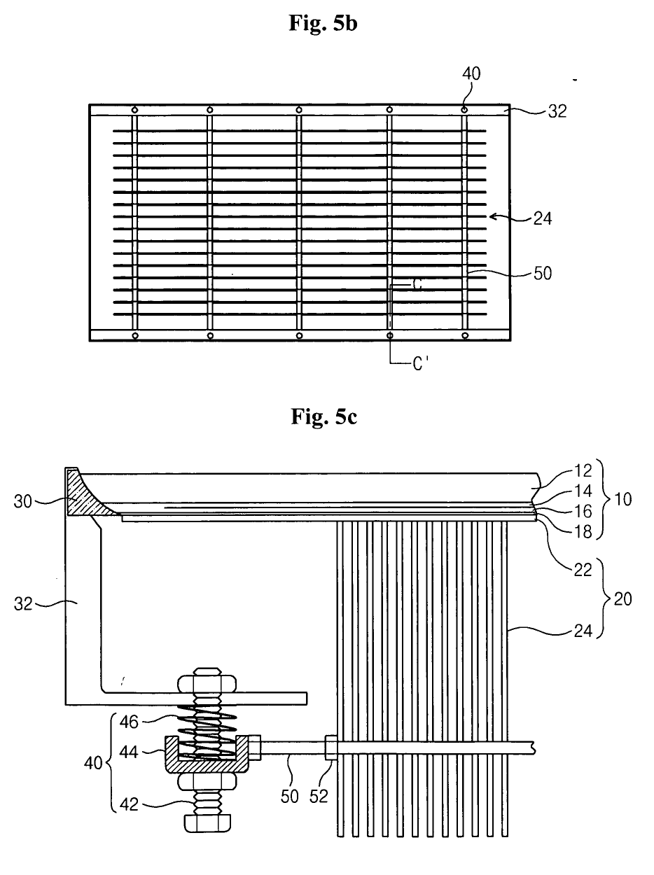

FIG. 5a and FIG. 5b are views showing a top and a bottom of a photovoltaic power generating unit according to another preferred embodiment. FIG. 5c is an exploded sectional view taken along the line C-C in FIG. 5b.

In a photovoltaic power generating unit shown in FIGS. 5a-5c, the configuration is almost same as that shown in FIGS. 4a-4c except that the elastic force fixation device 40 including the elastic force controller 42, the spring fixation element 44 and the spring 46 are provided on the lower part of the frame extension part 32. In addition, it is different from the photovoltaic power generating unit shown in FIG. 3a-3c in that a tension spring 46 instead of a compression spring is installed between the frame extension part 32 and the spring fixation element. The radiating part 20 is stably fixed to the solar cell module 10 under tension force exerted by the tension spring 46.

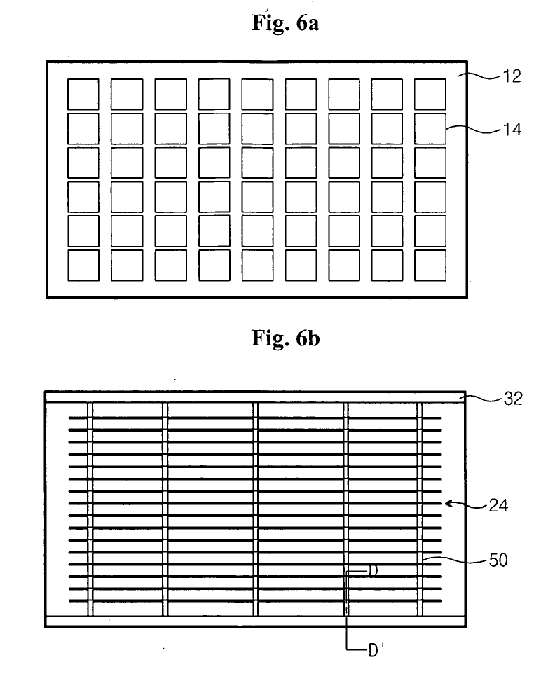

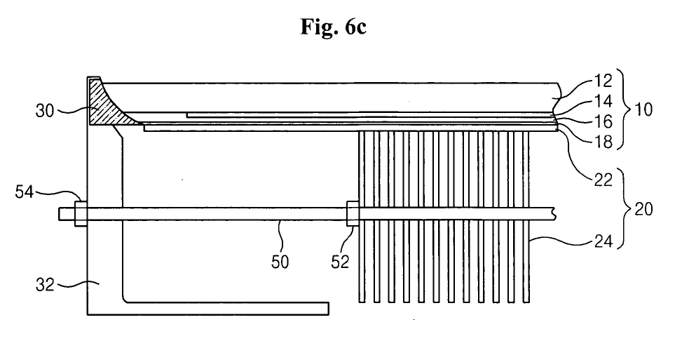

FIG. 6a and FIG. 6b are views showing the top and bottom of a photovoltaic power generating unit according to another preferred embodiment. FIG. 6c is an exploded sectional view taken along line D-D in FIG. 6b.

In the photovoltaic power generating unit shown in FIGS. 6a-6c, the configuration is almost the same as that shown in FIGS. 4a-4c except that the elastic force fixation device 40 including the elastic force controller 42, the spring fixation element 44 and the spring 46 are removed, and instead, the radiating fin support 50 is directly fixed to the frame extension part 32, parallel to the radiating plate 22, by a predetermined fastening means 54, such as a nut, thereby making the configuration of a photovoltaic power generating unit simple.

Until now, the radiating part 20 is described as the radiating plate 22 or a combination of the radiating plate 22 and the radiating fin 24, but it is apparent to the person skilled in the art that radiation is performed only by the radiating fin 24 without the radiating plate 22. At this point, each radiating fin 24 is directly bonded to the lower part of the protective member 18 with a thermal resin bonding agent.

As described above, in the photovoltaic power generating unit according to the present invention, the heat created by light concentrated on a solar cell in a concentrating type solar cell module is radiated to the atmosphere through radiating fins and a radiating plate, and the radiating fins and the radiating plate are stably fixed to the solar cell module by a spring and a radiating fin fixation part. In particular, a deformation of the radiating fins due to heat is prevented through the installment of the radiating fin fixation part. Meanwhile, even when a thermal resin bonding agent melts down due to heat, a fixation of the radiating part to the solar cell module is kept, thereby easily dissipating heat to the atmosphere.

It will be apparent to those skilled in the art that various modifications and variations can be made in a photovoltaic power generating unit of the present invention without departing from the scope of the invention. Thus, it is intended that the present invention covers the modifications and variations of the invention provided that they fall within the scope of the appended claims and their equivalents.

What is claimed is:

1. A photovoltaic power generating unit including a concentrating type solar cell module (10) mounted with a plurality of solar cells (14) and a concentrating device for concentrating sun light on the solar cell (14):
a radiating part (20) consisting of a radiating plate (22) attached to the lower part of the solar cell module (10) and a plurality of radiating fins (24) protruding downwardly from the lower part of the radiating plate (22) and arranged parallel to each other;
a pair of frames (30) provided on both edges of the solar cell module (10) for entirely supporting the solar cell module (10);
a frame extension part (32) each of which is downwardly extended from the frame (30) and a part of which is arranged parallel to the radiating plate (22);
at least one elastic force fixation device (40) provided to the frame extension part (32) and stably fixing the radiating part (20) to the solar cell module; and
a plurality of radiating fin supports (50) penetrating through a plurality of radiating fins (24) and connected to the elastic force fixation device (40) to support the radiating fins.

2. A photovoltaic power generating unit of claim 1, wherein the elastic force fixation device (40) consists of a supporting part connected to the frame extension part (32) and protruding upwardly, and an elastic part fitted between the supporting part and the radiating plate (22).

3. A photovoltaic power generating unit of claim 2, wherein the supporting part consists of a spring fixation element (44) for securely fixing the spring of the elastic part, and a elastic force controller (42) for controlling the elastic force of the spring.

4. A photovoltaic power generating unit of claim 1, wherein the radiating support (50) includes a radiating fin fixation element (52) arranged tightly to at least one radiation fin for fixing the radiating fin support (50) to the radiating fin (24).

5. A photovoltaic power generating unit including a concentrating type solar cell module (10) mounted with a plurality of solar cell (14) and a concentrating device for concentrating sun light on the solar cell (14):
a radiating part (20) consisting of a radiating plate (22) attached to the lower part of the solar cell module (10) and a plurality of radiating fins (24) protruding downwardly from the lower part of the radiating plate (22) and arranged parallel to each other;
a pair of frames (30) provided on both edges of the solar cell module (10) parallel to the radiating fins (24) for entirely supporting the solar cell module (10);
a frame extension part (32) protruding to the lower part of the frame; and
a plurality of radiating fin supports (50) penetrating through a plurality of radiating fins (24) and connected to the frame extension part (32), thereby stably fixing the radiating fins.

6. A photovoltaic power generating unit of claim 5, wherein the radiating fin support (50) includes a radiating fin fixation element (52) arranged tightly to at least one radiation fin for fixing the radiating fin support (50) to the radiating fin (24).

7. A photovoltaic power generating unit of claim 6, further comprising an elastic force fixation device (40) consisting of a supporting part protruding upwardly and downwardly, and a elastic part fitted between the supporting part and the frame extension part (32), wherein the radiating support (50) is connected to the frame extension part (32) through the elastic force fixation device (40).

8. A photovoltaic power generating unit of claim 7, wherein the supporting part consists of a spring fixation element (44) for securely fixing the spring of the elastic part, and an elastic force controller (42) for controlling the elastic force of the spring.
